(19) United States
(12) Patent Application Publication
(10) Pub. No.: US 2007/0291663 A1
(43) Pub. Date: Dec. 20, 2007

(54) Method and apparatus for scale-free topology generation in relay based wireless networks

(75) Inventors: Sudhir Dixit, Helsinki (FI); Evsen Yanmaz, Pittsburgh, PA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/454,789

(22) Filed: Jun. 19, 2006

(51) Int. Cl. H04L 12/28; H04L 12/56

(52) U.S. Cl. 370/254; 370/400

(57) ABSTRACT

A method of placing nodes in an area that requires coverage, the method includes the step of creating a network topology such that the average path length is kept to a minimum number of hops at the time of placement of a new node, wherein a limit is placed on a number of neighbors at the time of placement of the new node, the number being a parameter that impacts the average path length, resiliency and capital investment. The new node is connected to at least one node in the network.

### BACKGROUND OF THE INVENTION

1. Field of the Invention

The present invention relates to a wireless-fixed relay network, and more particularly, to a method of placing fixed relays in the hybrid network and updating a connectivity map after placing new fixed relays in the network.

2. Description of the Related Art

Traditional cellular networks include base stations or access points that are controlled by a Mobile Switching Center, wherein communications is performed over single hop wireless links between base stations and mobile stations. To provide additional services to mobile subscribers, to extend the range and coverage of the mobile services provided and to enhance network performance and system efficiencies, overlay fixed relay network with no infrastructure may be deployed. Fixed relays, for example Wireless LAN access points, can be used to connect mobile nodes that are not covered by any base stations, to the Internet at a low cost and to relay traffic on-demand. Fixed relays also provide an overlay access technology that may co-exist and inter-operate with cellular access networks. In addition to coverage extension, fixed relays provide robustness and traffic management features to existing networks. For example, when a base station fails or is congested, the traffic destined to the base station may be forwarded to other base stations via fixed relays.

Despite the advantages of overlaying fixed relay networks over traditional cellular networks, the scalability of a hybrid network which combines a cellular network and ad hoc wireless network(s), especially relay-based wireless networks, has not been studied. Most of the previous works on wireless network studied ad hoc wireless networks that include nodes, such as mobile nodes, that are placed randomly in the network and these works tried to achieve scalable routing protocols for such networks. Some well known ad hoc routing protocols that aim to reduce delays across the network, i.e., the number of hops between the source and destination nodes, include what one knows as hierarchical state routing and zone routing protocols.

Hierarchical state routing protocol includes multi-level clustering and partitioning of mobile nodes, wherein each mobile node knows the state-information within its cluster and the cluster-heads exchange state information through gateways. In the zone routing protocol, a zone that includes nodes within a specified number of hops is defined for each node. Within the zone, a proactive table-driven routing scheme is used, whereas between the zones a reactive routing scheme is used. Both the hierarchical state routing and the zone routing protocols try to achieve a scalable routing protocol for a randomly generated network topology.

In addition, a small-world network model and a scale-free network model have been proposed to achieve a small average path length in complex networks, such as the Internet. Small-world and scale-free network models try to achieve a network where each node can reach every other node in the network with a minimum number of hops, independent of the number of nodes in the network. Basically, in the small-world network model, the average path length is small, i.e., most nodes are a few hops away from each other, and the clustering coefficient is high. The clustering coefficient is defined as the average fraction of pairs of neighbors of a node that are also neighbors of each other calculated over the whole network. To form the small-world network model, a current method interpolated between a regular lattice and a random graph. By randomly re-wiring a few edges, this current method reduced the average distance between nodes, but it had little effect on the clustering coefficient. When forming the small-world model, the number of nodes in the network is kept fixed and the re-wired edges are randomly picked. Thus, the small-world model has shown that by introducing some randomness/shortcuts while forming the links between the nodes, the average path length in the network may be significantly reduced while the clustering coefficient is kept high.

In scale-free networks, on the other hand, the degree distribution of the nodes is in power-law form, i.e., most nodes have very few connections and few nodes called hubs have many connections. The scale-free network model, in one current approach, is formed by starting with a small number of (m₀) nodes, and at each time step, adding a new node with m (<=m₀) edges that will be connected to the nodes already present in the system. When choosing the nodes to which the new node is to connect, it is assumed that the probability that a new node will be connected to a node depends on the connectivity/degree of that node. The degree of a node is defined as the total number of connections/links to the node and the average of the degrees of all nodes in the network is known as the average degree. Thus, the larger the degree, the “more important” the node is in the network.

A recent approach applies the small-world model to ad hoc wireless networks by randomly rewiring some links, using physical wires. It has been shown that randomly rewiring some links with physical wires provides for different node distribution in the network, thus small-world model effects can be obtained in ad hoc wireless networks. Information is used to find contacts/shortcuts in the network to be used for resource discovery and savings in terms of the amount of overhead. In this approach, the selection of contacts in the network is not performed randomly. There are some similarities between this approach and the zone routing protocol, wherein every node in this approach has its own view of the network, also called a zone, and the size of the zone is limited by a given number of hops. To communicate with out-of-zone nodes, a node will need contacts, where contacts are located r hops away and r is a design parameter. In this approach, protocols for contact selection and location are introduced. However, it should be noted that rewiring links using physical wires is an unrealistic solution in wireless networks.

There are no current solutions for achieving scalable routing protocols for such hybrid cellular-fixed relay networks. When fixed relays are being overlaid in a hybrid network, the problem on where to place fixed relays in order to achieve scalability in the “next generation”, multi-hop, relay-based wireless networks while, on average, simultaneously minimizing the number of hops or latency must be solved. Specifically, the placement of fixed relays must be performed such that any new relays are within a range of at least one previously deployed relay or base station.

### SUMMARY OF THE INVENTION

The present invention, in one embodiment, is directed to a method of placing nodes in an area that requires coverage. The method includes the step of creating a network topology such that the average path length is kept to a minimum number of hops at the time of placement of a new node, wherein a limit is placed on a number of neighbors at the time of placement of the new node, the number being a parameter that impacts the average path length, resiliency and capital investment. The new node is connected to at least one node in the network. Optionally the invention may be further directed to a method of updating a multi-hop connectivity map and to a method of routing traffic between nodes according to a predetermined routing criterion.

Another embodiment of the invention is directed to an apparatus for placing nodes in an area that requires coverage. The apparatus includes a creating unit for creating a network topology such that the average path length is kept to a minimum number of hops at the time of placement of a new node, wherein a limit is placed on a number of neighbors at the time of placement of the new node. The new node is connected to at least one node in the network. Optionally the invention may be further directed to a method of updating a multi-hop connectivity map and to a method of routing traffic between nodes according to a predetermined routing criterion.

Yet another embodiment of the invention is directed to an apparatus that includes creating means for creating a network topology such that the average path length is kept to a minimum number of hops at the time of placement of a new node, wherein a limit is placed on a number of neighbors at the time of placement of the new node. The new node is connected to at least one node in the network. Optionally the invention may be further directed to a method of updating a multi-hop connectivity map and to a method of routing traffic between nodes according to a predetermined routing criterion.

Yet another embodiment of the invention is directed to a computer program product embodied on a computer readable means. The computer program product is configured to perform the step of creating a network topology such that the average path length is kept to a minimum number of hops at the time of placement of a new node, wherein a limit is placed on a number of neighbors at the time of placement of the new node. The new node is connected to at least one node in the network.

The limited number of neighbors, for a new node to be placed, is a parameter that impacts the average path length, resiliency and capital investment.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates an embodiment of a hybrid cellular and relay-based wireless overlay network for implementing the present invention;

FIG. 2a illustrates an embodiment of the invention wherein disjoint clusters are connected through a wired backbone;

FIG. 2b illustrates an embodiment of the invention wherein disjoint clusters are connected through a high capacity high power (HCHP) fixed relay station; and

FIG. 3 illustrates a combined algorithm that generates fixed relays and base stations locations/topology and a connectivity map incrementally, after the addition of each fixed relay.

### DETAILED DESCRIPTION OF PREFERRED EMBODIMENTS

Reference will now be made to preferred embodiments of the present invention, examples of which are illustrated in the accompanying drawings. The present invention achieves a scalable network by applying a small-world network model and a scale-free network model to a joint cellular and fixed relay network that is envisioned for the next generation of wireless networks. As implemented in the present invention, each fixed relay in the network can reach at least one base station in a geographical coverage area through a minimum number of hops. In an embodiment of the present invention, a node is defined as a fixed relay or base station.

It should be noted that a fixed relay network is a form of a multi-hop ad hoc wireless network that is controlled by service providers, for example through base stations. In the fixed relay network, the traffic of many mobile users are forwarded through the fixed relays, possibly through multiple hops according to a routing protocol, but preferentially directly to the nearest base station, if the base station is operating under a preset loading threshold. Thus, the scalability of the fixed relay network is a major concern to be able to meet quality of service requirements, such as delay and bandwidth for both real time and non-real time traffic. Range limitations associated with fixed relays, due to power and interference concerns, add a new constraint that is not present in wired networks, thus, making it harder to arrive at an optimal topology. From the service provider's point of view, it is desirable to cover a geographical area with as few relays as possible, thereby keeping the overlap areas to a minimum. However, by doing so, the number of neighbors of each fixed relay is decreased and hence the average path length, i.e., the average number of hops, in the network is increased, making it more difficult to fulfil the quality of service requirements.

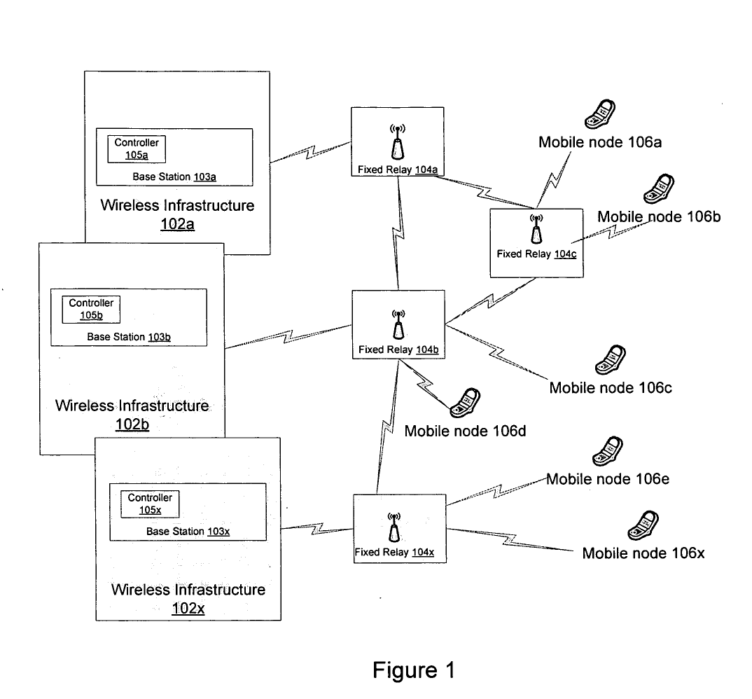

FIG. 1 illustrates an embodiment of a hybrid cellular and relay-based wireless overlay network for implementing the present invention. The network of FIG. 1 includes multiple network infrastructure 102a-102x, multiple fixed relays 104a-104x multiple mobile nodes 106a-106x. The present invention extends the coverage of base stations 103a-103x of network infrastructure 102a-102x via fixed relays 104a-104x that are strategically located in a geographical area by a controlling node, for example controller 105 in base station 103. In an embodiment of the invention, a number of base stations 103 are placed such that the coverage area of base stations 103 slightly overlaps. New fixed relays 104 are placed to cover the geographical area with the fewest number of fixed relays 104 and also to have a small average path length so that fixed relays 104 can reach at least one base station with a small number of hops. Each fixed relays 104 basically receive signals from various mobile users 106 and other fixed relays 104, within their range, and transmit the received data to the next fixed relay 104 or base station 103 in a route. In an embodiment of the invention, fixed relays 104 do not have any infrastructure, i.e., they communicate through air interfaces and the range of fixed relays 104 is limited due to the concerns of, for example, power and interference. As is apparent to one skilled in the art, a geographical area has a number of base stations 103, thus one fixed relay 104 is placed at a time at strategic locations, thereby growing the network continuously.

Instead of finding a routing protocol for a randomly generated network of mobile nodes, the present invention creates a wireless network connectivity topology using the scale-free network criteria such that the average path length is small. The present invention also provides a method for locating fixed relays 104 in the network. Because the small-world and scale-free network models are not readily applicable to wireless networks, due to range limitations associated with fixed relays 104, to place fixed relays 104, an embodiment of the present invention implements a decision metric. Specifically, instead of placing a newly added fixed relay near highly connected fixed relays 104 in the network or connecting some of fixed relays 104 with wires, as currently proposed, the present invention puts a limit on the number of neighbors at the time of placement of each fixed relay 104. This limit on the number of neighbors at the time of placement of each fixed relay 104 is a design parameter that determines the extent of coverage that can be achieved by a given number of fixed relays and the average path length that is achievable between fixed relays 104 and base stations 103.

Once fixed relays 104 are placed in a geographical area, an embodiment of the present invention generates a multi-hop connectivity map at the radio/MAC layer and routes the traffic between fixed relays 104. The routing criteria can be, for example, to minimize the number of hops, the number of congested links, to minimize delays and to maximize network throughput. Thus, in this respect, the location, selection and number of fixed relays 104 are important design parameters. In an embodiment of the present invention, the routing scheme achieves high system utilization by efficient use of network resources, such as bandwidth.

Specifically, in an embodiment of the invention, a load balancing based routing scheme is used to pick a route with the fewest number of hops to the least loaded base station, for example 103b. Since the least loaded base station 103b may not be the one that can be reached by the minimum number of hops, a joint performance metric is used to determine an optimum path. Furthermore, when load balancing is performed, the type of traffic, both real-time traffic and non real-time traffic, is taken into account. While the different types of traffic can be put in separate queues when the network is started, the packets that are re-routed to the less loaded base station 103b are chosen such that the delay experienced by these packets fall in line with the quality of service requirements. Thus, the real-time packets may be routed to use the shortest path to achieve a smaller delay, whereas the non real-time packets can be re-routed through, possibly longer, alternative routes to achieve load balancing.

When a new node/fixed relay 104 is added to the connectivity map, it can be connected preferentially to existing nodes with large number of wireless connections while retaining a previously generated connectivity map. Because each fixed relay 104 in the present invention can reach at least one base station 103 with a minimum number of hops, some fixed relays 104 may possibly not reach each other. When fixed relays 104 are clustered around base stations, this may result in disjoint clusters and could lead to poor load balancing performance. To overcome the disjoint clusters problem, the present invention uses high capacity, high power (HCHP) relay stations in between the disjoint clusters, so that the excess traffic of the congested base station, for example base station 103x, can be forwarded to other non-congested base stations, for example base station 103b, in the network.

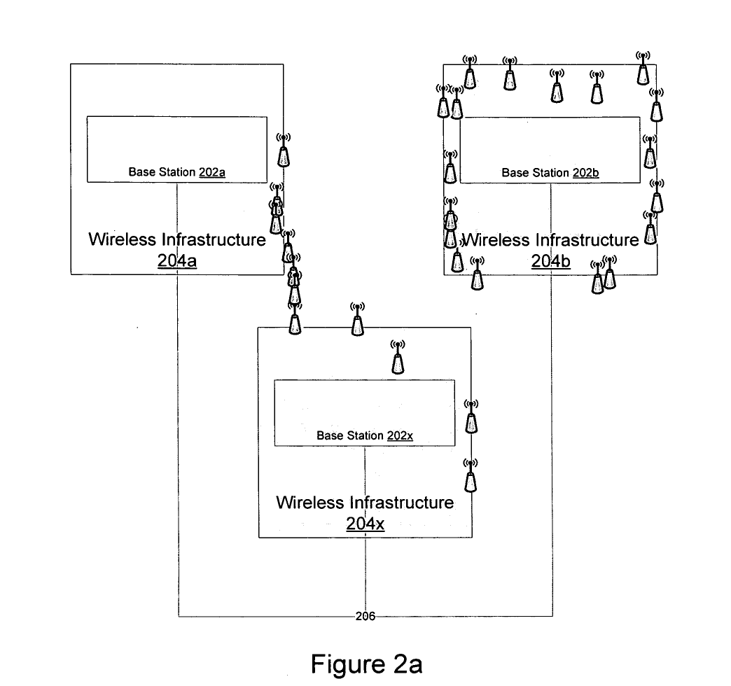

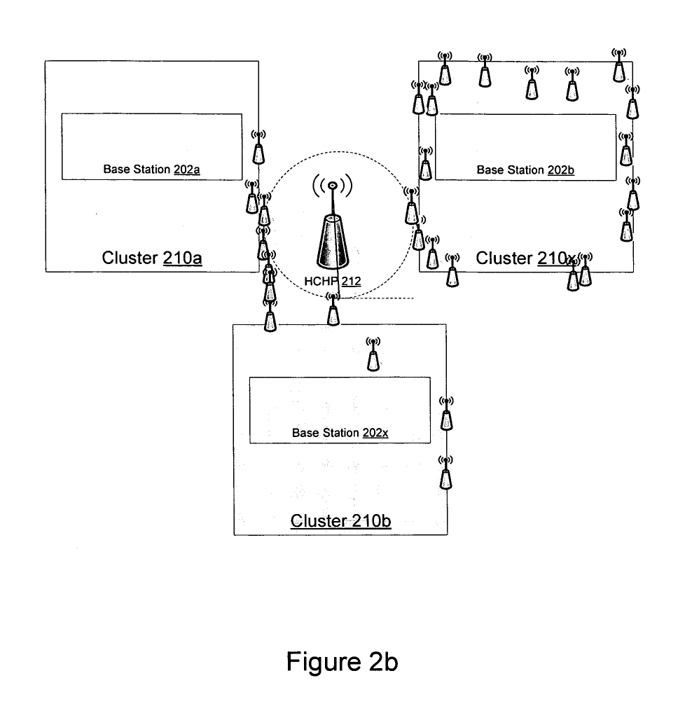

FIG. 2a illustrates an embodiment of the invention wherein disjoint infrastructures (clusters) are connected through a wired backbone. In FIG. 2a, base stations 202 of wireless infrastructure 204 are connected by wired backbone 206. FIG. 2a also shows that disjoint clusters 208 are connected through wired backbone 206.

FIG. 2b illustrates an embodiment of the invention wherein disjoint clusters are connected through a HCHP fixed relay. In FIG. 2b, disjoint clusters 210 are connected through HCHP fixed relay 212. The location and the number of the HCHP fixed relays 212 can be determined according to a predetermined algorithm. For example, because the locations of the regular fixed relays 104 are known, the present invention may find the center of gravity of disjoint clusters 210, as illustrated in FIG. 2b. Once the center of clusters 210 are found, a HCHP fixed relay 212 may be placed in the center of the line connecting the clusters' centers. If the coverage of HCHP fixed relay 212 is not sufficient to connect disjoint clusters 210, additional fixed relay(s) 104 can be placed along the line connecting the cluster centers. More efficient algorithms that minimize the number of additional HCHP fixed relays 212 also may be used to obtain the benefits of the present invention.

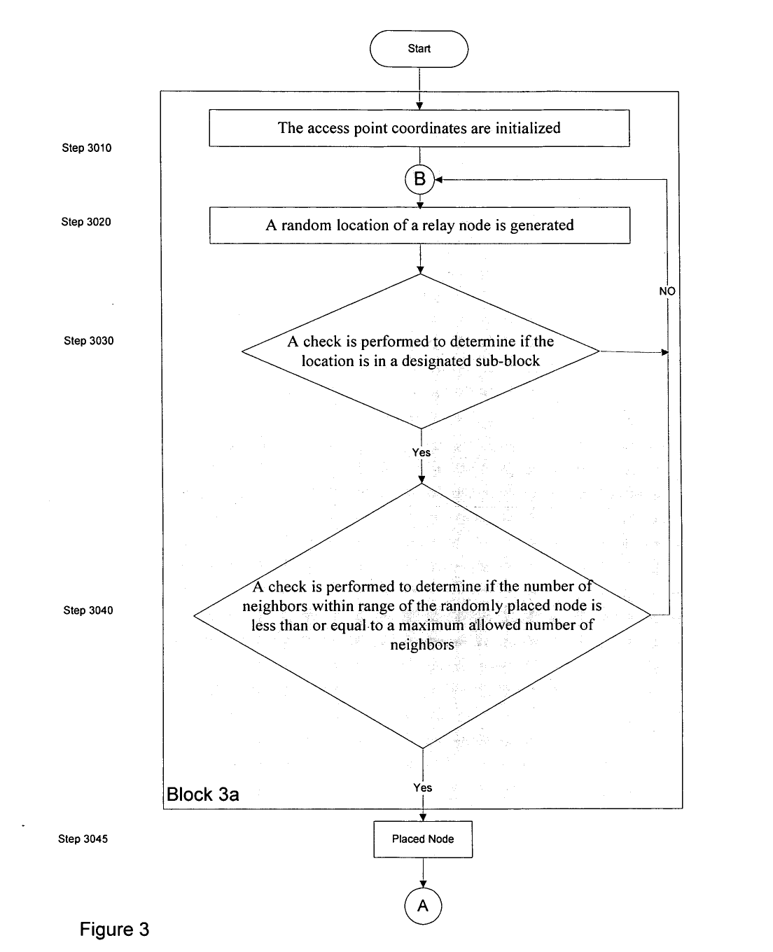

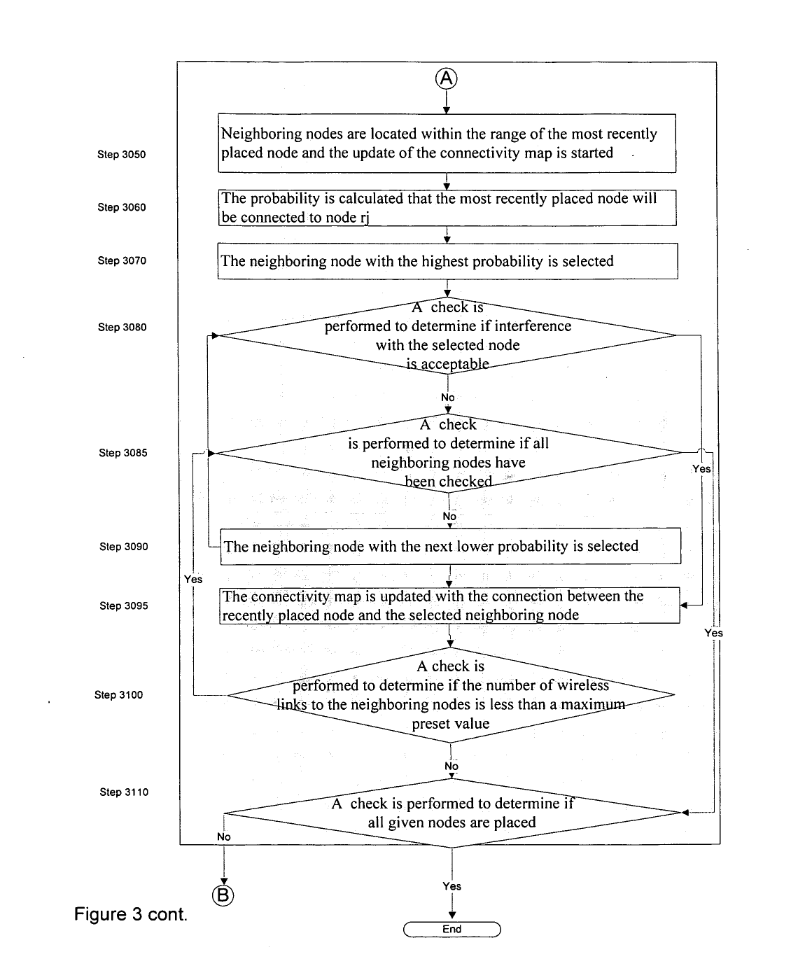

FIG. 3 illustrates a combined algorithm that generates the fixed relays and base stations locations/topology and a connectivity map incrementally, after the addition of each fixed relay 104. The first portion of FIG. 3, block 3a, illustrates a flow diagram for generating a topology of base stations and fixed relays. In step 3010, the access point coordinates are initialized. In Step 3020, a random location of a relay node is generated. In Step 3030, a check is performed to determine if the location is in a designated sub-block. If the check of step 3030 is negative, the algorithm returns to step 3020. If the check is positive, in Step 3040, another check is performed to determine if the number of neighbors within range of the randomly placed node 104 is less than or equal to a maximum allowed number of neighbors. If the check of step 3040 is negative, the algorithm returns to step 3020. If the check of step 3040 is positive, the algorithm goes to block 3b for generating a connectivity update map after a new fixed relay has been placed, as illustrated in step 3045.

In Step 3050 of block 3b, neighboring nodes, i.e., fixed relays and base stations, are located within the range of the most recently placed node 104, call it r0, and the update of the connectivity map is started. During this update process, connections to neighboring nodes are established from the recently placed node (r0) based on connection probability and the interference levels to its neighboring nodes. A limit is placed on the maximum number of connections the most recently placed fixed relay r0 can have to its neighboring nodes.

In Step 3060, a call is placed to neighboring nodes r1, r2 . . . r1 and the probability (pi) is calculated that node r0 will be connected to node rj (j=1 . . . I). Because the degree of node rj is known as kj, pi=kj/Σkj(for all j). In Step 3070, the neighboring node with the highest probability is selected. In Step 3080, a check is performed to determine if interference with the selected node is acceptable. If the determination of step 3080 is unsuccessful, it is determined in step 3085 if all possible connections to the neighboring nodes have been checked. If this is the case, the algorithm jumps to step 3110 in order to check if all given nodes are placed (step 3110 is described later in more detail). If the result of Step 3085 is that not all possible connections to neighboring nodes were checked yet, the algorithm continues with Step 3090 where the neighboring node with the next lower probability is selected and the algorithm returns to step 3080. If the determination of step 3080 is successful, the connectivity map is updated in Step 3095 with the connection between the recently placed node and the selected neighboring node, and it is checked in Step 3100, if the number of wireless links to the neighboring nodes is less than a maximum preset value. If the determination of step 3100 is successful, the algorithm returns to step 3085. If the determination of step 3100 is unsuccessful, the algorithm determines, in Step 3110, if all given nodes have been placed. If the determination of step 3110 is successful, the algorithm ends, otherwise the algorithm returns to step 3020 to place the next access node 104.

In previous solutions of achieving a scalable hybrid network, the focus was on achieving a scalable routing protocol for a given randomly generated network. However, real networks are not purely random as they have some structure. In an embodiment of the present invention, fixed relays 104 are not randomly placed in the geographical area; on the contrary, the fixed relays 104 need to reach at least one base station 103 in the network to provide services to the mobile nodes 106 within their coverage area. Therefore, instead of randomly placing fixed relays 104 and then trying to find a scalable routing protocol to connect these fixed relays, as previously proposed, an embodiment of the present invention provides a novel method of placing fixed relays such that the network is scalable, i.e., fixed relays 104 can reach to base stations 103 with a small number of hops, independent of the number of fixed relays in the network. In the present invention, once the topology is fixed and their (mesh) connectivity at the radio/MAC layer optimised, a load-balancing “scale-free” routing protocol may be designed to meet key quality of service requirements, such as delay, bandwidth, and throughput. In addition, although the present invention is illustrated above in a hybrid network of base stations and fixed relays, the present invention may also be applied to pure ad hoc wireless networks and sensor networks.

It should be appreciated by one skilled in art, that the present invention may be utilized in any device that implements the hybrid network described above. The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A method for placing nodes in an area that requires coverage, the method comprising:
creating a network topology such that the average path length is kept to a minimum number of hops at the time of placement of a new node, wherein a limit is placed on a number of neighbors at the time of placement of the new node,
wherein the new node is connected to at least one node in the network.

2. The method of claim 1, wherein after the placing of the new node, the method further comprises updating a connectivity map to connect the newly placed node to the network.

3. The method of claim 2, where after updating the connectivity map, the method further comprises routing traffic between nodes according to predetermined routing criteria.

4. The method of claim 1, wherein the step of creating the network topology further comprises:
initializing coordinates associated with any type of access point;
generating a random location for the new node;
performing a first determining step to determine if the location of the new node is in a designated sub-block;
if the first determining step is successful, performing a second determining step to determine if the number of neighbors within range of the new node is less than or equal to a maximum allowed number of neighbors, wherein a limit is placed on the number of neighbors;
if the second determining step is successful, placing the node and continuing with a connectivity map update; and
if one of the first and second determining steps is unsuccessful, returning to the generating step without placing the node.

5. The method of claim 2, wherein the step of updating the connectivity map further comprises the steps of:
calculating probabilities with which the newly placed node will be connected to a plurality of neighboring nodes;
selecting a neighboring node with a highest probability;
performing a first determining step to determine if interference with the neighboring node is acceptable;
if the first determining step is unsuccessful, performing a second determining step to determine if all possible connections to the neighboring nodes have been checked;
if the second determining step is successful, performing a fourth determining step;
if the second determining step shows that not all possible connections to the neighboring nodes have been checked, selecting a neighboring node with the next lower probability from a plurality of neighboring nodes within a predefined reachable range and returning to the first determining step;
if the first determining step is successful, updating the connectivity map with a connection between the recently placed node and the selected neighboring node and continuing to a third determining step;
performing the third determining step to determine if a number of wireless links to the neighboring nodes is less than a maximum preset value;
if the third determining step is successful, returning to the second determining step;
if the third determining step is unsuccessful, performing the fourth determining step to determine if all given relays have been placed;
if the fourth determining step is successful, completing the node placement process; and
if the fourth determining step is unsuccessful, continuing with placement of a next new node.

6. The method of claim 1, further comprising placing one or more high power relay stations between disjoint clusters of nodes.

7. The method of claim 6, further comprising determining locations and numbers of high power relay stations according to a predetermined algorithm.

8. The method according to claim 7, further comprising locating a center of gravity of disjoint clusters and placing one or more high power relay stations along in a line that connects the centers of the disjoint clusters.

9. The method of claim 8, further comprising placing one or more nodes along the line connecting the centroids of the two clusters if the range of the one or more high power relay stations is insufficient to connect the disjoint clusters.

10. The method of claim 1, further comprising determining an extent of coverage that can be achieved by a given number of nodes and the average path length that is achievable between relays and base stations.

11. The method of claim 3, further comprising determining a routing criterion according to at least one of a minimum number of hops, avoiding of congested links, minimizing transmission delays, maximizing network throughput and load balancing

12. The method of claim 11, further comprising placing different types of traffic in different queues.

13. The method of claim 1, wherein the area requiring coverage is a cellular network and the nodes in the network at least one of base stations or relay nodes.

14. An apparatus for placing nodes in an area that requires coverage, the apparatus comprises:
a creating unit for creating a network topology such that the average path length is kept to a minimum number of hops at the time of placement of a new node, wherein a limit is placed on a number of neighbors at the time of placement of the new node, wherein the new node is connected to at least one node in the network.

15. The apparatus of claim 14, further comprising an updating unit for updating a connectivity map to connect the newly placed node to the network.

16. The apparatus of claim 15, further comprising a routing unit for routing traffic between nodes according to predetermined routing criteria.

17. The apparatus of claim 14, wherein the creating unit is configured to:
initialize coordinates associated with any type of access point in the wireless network;
generate a random location for the new node;
perform a first determining step to determine if a location of the new node is in a designated sub-block;
if the first determining step is successful, perform a second determining step to determine if the number of neighbors within range of the new node is less than or equal to a maximum allowed number of neighbors, wherein a limit is placed on the number of neighbors;
if the second determining step is successful, place the node and continue with the connectivity map update; and
if one of the first and second determining steps is unsuccessful, return to generate another random location for the new node without placing the new node.

18. The apparatus of claim 15, wherein the updating unit is configured to update the connectivity map and is further configured to:
calculate the probability with which a newly placed node will be connected to a plurality of neighboring nodes;
select a neighboring node with a highest probability;
perform a first determining step to determine if interference with the neighboring node is acceptable;
if the first determining step is unsuccessful, perform a second determining step to determine if all possible connections to the neighboring nodes have been checked;
if the second determining step is successful, perform a fourth determining step;
if the second determining step shows that not all possible connections to the neighboring nodes have been checked, select a neighboring node with the next lower probability from a plurality of neighboring nodes within a predefined reachable range and returning to the first determining step;
if the first determining step is successful, update the connectivity map with a connection between the recently placed node and the selected neighboring node and continue to a third determining step;
perform the third determining step to determine if a number of wireless links to the neighboring nodes is less than a maximum preset value;
if the third determining step is successful, return to the second determining step;
if the third determining step is unsuccessful, perform the fourth determining step to determine if all given relays have been placed;
if the fourth determining step is successful, complete the node placement process; and
if the fourth determining step is unsuccessful, continue with placement of a next new node.

19. The apparatus of claim 14, wherein a placing unit for placing one or more high power relay station in between disjoint clusters of nodes.

20. The apparatus of claim 14, further comprising a determining unit for determining locations and numbers of high power relay stations according to a predetermined algorithm.

21. The apparatus of claim 20, wherein the determining unit is configured to locate a center of gravity of disjoint clusters and place one or more high power relay stations in a line that connects the centers of the disjoint clusters.

22. The apparatus of claim 21, wherein the determining unit is configured to place one or more nodes along the line if the range of one or more high power relay station is insufficient to connect the disjoint clusters.

23. The apparatus of claim 14, further comprising a determining unit for determining an extent of coverage that can be achieved by a given number of nodes and the average path length that is achievable between relays and base stations.

24. The apparatus of claim 14, further comprising a determining unit for determining a routing criterion according to at least one of a minimum number of hops, avoiding of congested links, minimizing transmission delays, maximizing network throughput and load balancing.

25. The apparatus of claim 24, further comprising a placing unit for placing different types of traffic in different queues.

26. The apparatus of claim 14, wherein the area requiring coverage is a cellular network and the nodes in the network are base stations and/or relay nodes.

27. An apparatus, comprising a creating means for creating a network topology such that the average path length is kept to a minimum number of hop at the time of placement of a new node, wherein a limit is placed on a number of neighbors at the time of placement of the new node and wherein the new node is connected to at least one node in the network.

28. The apparatus of claim 27, further comprising an updating means for updating a connectivity map to connect the newly placed node to the network.

29. The apparatus of claim 27, further comprising a routing means for routing traffic between nodes according to predetermined routing criteria.

30. A computer program product embodied on a computer readable means, the computer program product being configured to perform the step of:
creating a network topology such that the average path length is kept to a minimum number of hops at the time of placement of a new node, wherein a limit is placed on a number of neighbors at the time of placement of the new node and the new node is connected to at least one node in the network.

31. The computer program product of claim 30, wherein the computer program product is further configured to perform the steps of:
updating a connectivity map to connect the newly placed node to the network; and
routing traffic between nodes according to predetermined routing criteria.

32. The computer program product of claim 30, wherein the computer program product is directly loadable into the internal memory of a computer.
